(19) United States
(12) Patent Application Publication
(10) Pub. No.: US 2026/0252345 A1
(43) Pub. Date: Aug. 27, 2026

(54) LAUNCHING VERSIONS OF CLOUD BASED ENTERPRISE MULTI TENANT WEB APPLICATIONS BASED ON TENANT

(71) Applicant: GE Precision Healthcare LLC, Waukesha, WI (US)

(72) Inventors: Jithin Anneri Kundacheri, Bangalore (IN); Annapurna Samanta, Bhubaneswar (IN)

(21) Appl. No.: 19/062,907

(22) Filed: Feb. 25, 2025

(51) Int. Cl. G06F 8/71

(52) U.S. Cl. CPC G06F 8/71

(57) ABSTRACT

One or more systems, computer program products and/or computer-implemented methods provided herein relate to launching different versions of an enterprise multi-tenant cloud based web application in a single URL. Accordingly, a system can comprise a memory that stores computer executable components. The system can further comprise a processor that executes at least one of the computer executable components. The computer executable components can comprise an origin component that retrieves application version metadata, determines a first origin corresponding to a first version of an application and a second origin corresponding to a second version of the application, and resolves a network route to either the first origin or the second origin. The computer executable components can further comprise a token component that generates a token, embeds a claim within the token, and issues the token. The computer executable components can additionally comprise a compatibility component that selects which origin to use.

### TECHNICAL FIELD

The subject disclosure relates generally to launching different versions of an enterprise multi-tenant cloud based web application, and more specifically to launching multiple versions in a single URL based on tenants.

### BACKGROUND

Enterprise cloud-based multi-tenant web applications allow multiple organizations (tenants) to access and utilize shared platforms while maintaining secure data. Newer versions of these applications are continually developed and deployed to improve functionality, security, or performance. However, transitioning tenants from one version to another presents a significant challenge.

Traditionally, enterprises conduct Market Enablement (ME) to assess and validate new versions before a full-scale rollout. However, this process is often time-consuming and is performed on a different URL, leading to delays in making the latest version available to all tenants. The need to accelerate the deployment of new versions while maintaining system stability necessitates a robust migration strategy that allows tenants to transition individually without disrupting other tenants.

Existing deployment strategies such as Blue-Green deployments, A/B testing, and canary releases are commonly used to support multiple versions of an application. However, these approaches primarily focus on infrastructure-level deployments and fail to address the unique challenge of serving different versions of an enterprise web application within a single URL. In conventional multi-tenant architectures, when a user accesses an application, they are directed to a login page, and only after authentication can the system determine which version the tenant should use, resulting in unnecessary complexity and can cause disruptions to the user experience.

Accordingly, systems or techniques that can address one or more of these technical problems can be desirable.

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate launching multiple versions of cloud based enterprise multi-tenant web applications within a single URL.

According to one or more embodiments, a system is provided. The system can comprise a non-transitory computer-readable memory that can store computer-executable components. The system can further comprise a processor that executes at least one of the computer executable components that can retrieve application version metadata stored in a version mapping database, determine a first origin corresponding to a first version of an application and a second origin corresponding to a second version of the application by querying a distributed configuration management system, and resolving a network route to either the first origin or the second origin based on computed routing decisions. In various aspects, the at least one of the computer executable components can further generate a cryptographically signed token, embed a claim within the token, and issue the token. In various instances, the at least one of the computer executable components can further decrypt and inspect the claim within the token, extract metadata fields from the claim, evaluate the claim based on predefined routing rules, and select which origin to use.

According to one or more embodiments, a computer-implemented method is provided. In various embodiments, the computer-implemented method can comprise retrieving, by a system operatively coupled to a processor, application version metadata stored in a version mapping database. In various aspects, the computer-implemented method can comprise determining, by the processor, a first origin corresponding to a first version of an application and a second origin corresponding to a second version of the application by querying a distributed configuration management system. In various aspects, the computer-implemented method can comprise resolving, by the processor, a network route to either the first origin or the second origin based on computed routing decisions. In various instances, the computer-implemented method can comprise generating, by the processor, a cryptographically signed token. In various instances, the computer-implemented method can comprise embedding, by the processor, a claim within the token. In various aspects, the computer-implemented method can comprise issuing, by the processor, the token. In various instances, the computer-implemented method can comprise decrypting and inspecting, by the processor, the claim within the token. In various aspects, the computer-implemented method can comprise extracting, by the processor, metadata fields from the claim. In various instances, the computer-implemented method can comprise evaluating, by the processor, the claim based on predefined routing rules. In various aspects, the computer-implemented method can comprise selecting, by the processor, which origin to use.

According to one or more embodiments, a computer program product for facilitating launching multiple versions of cloud based enterprise multi-tenant web applications within a single URL is provided. In various embodiments, the computer program product can comprise a non-transitory computer-readable memory having program instructions embodied therewith. In various aspects, the program instructions can be executable by a processor to cause the processor to retrieve application version metadata stored in a version mapping database. In various cases, the program instructions can be further executable to cause the processor to determine a first origin corresponding to a first version of an application and a second origin corresponding to a second version of the application by querying a distributed configuration management system. In various aspects, the program instructions can be further executable to cause the processor to resolve a network route to either the first origin or the second origin based on computed routing decisions. In various cases, the program instructions can be further executable to cause the processor to generate a cryptographically signed token. In various aspects, the program instructions can be further executable to cause the processor to embed a claim within the token. In various cases, the program instructions can be further executable to cause the processor to issue the token. In various cases, the program instructions can be further executable to cause the processor to decrypt and inspecting the claim within the token. In various aspects, the program instructions can be further executable to cause the processor to extract metadata fields from the claim. In various aspects, the program instructions can be further executable to cause the processor to evaluate the claim based on predefined routing rules. In various cases, the program instructions can be further executable to cause the processor to select which origin to use.

### DESCRIPTION OF THE DRAWINGS

FIG. 1 illustrates a block diagram of an example, non-limiting system that facilitates launching multiple versions of cloud based enterprise multi-tenant web applications within a single URL in accordance with one or more embodiments described herein.

FIG. 2 illustrates a block diagram of an example, non-limiting system that facilitates launching multiple versions of cloud based enterprise multi-tenant web applications within a single URL in accordance with one or more embodiments described herein.

FIG. 3 illustrates a flow diagram of an example, non-limiting computer-implemented method that facilitates launching multiple versions of cloud based enterprise multi-tenant web applications within a single URL in accordance with one or more embodiments described herein.

FIG. 4 illustrates a flow diagram of an example, non-limiting computer-implemented method that facilitates launching multiple versions of cloud based enterprise multi-tenant web applications within a single URL in accordance with one or more embodiments described herein.

FIG. 5 illustrates an example, non-limiting system architecture 500 that can facilitate launching multiple versions of cloud based enterprise multi-tenant web applications within a single URL in accordance with one or more embodiments described herein.

FIG. 6 illustrates an example, non-limiting system architecture 600 that can facilitate launching multiple versions of cloud based enterprise multi-tenant web applications within a single URL in accordance with one or more embodiments described herein.

FIG. 7 illustrates a block diagram of an example, non-limiting operating environment in which one or more embodiments described herein can be facilitated.

FIG. 8 illustrates an example networking environment operable to execute various implementations described herein.

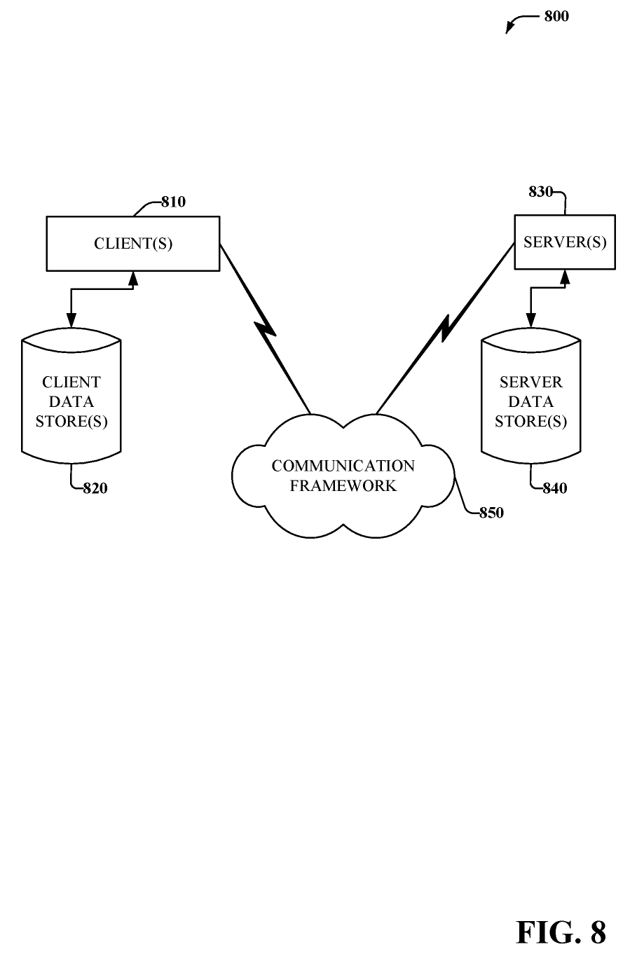

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Enterprise cloud-based multi-tenant web applications enable multiple tenants to access and utilize a shared platform while maintaining secure data isolation. These applications undergo continuous development, with newer versions being deployed to enhance functionality, security, and performance. However, transitioning tenants from one version to another poses significant challenges, particularly when ensuring minimal disruption to existing users while expediting the release of the latest version.

Traditionally, enterprises conduct Market Enablement to assess and validate new versions before a full-scale rollout. This process, however, is often time-consuming and is performed on a different URL, delaying the broader adoption of the latest version across all tenants. To mitigate these delays and facilitate a faster deployment cycle, a robust migration strategy is required—one that allows individual tenants to transition to the new version without impacting other tenants that continue to operate on the previous version.

Current deployment strategies primarily focus on infrastructure-level deployment and do not adequately address the challenge of dynamically serving different versions of a multi-tenant web application within a single URL. In conventional multi-tenant architectures, when a user accesses an application, they are directed to a login page, and only after authentication can the system determine which version the tenant should use, leading to unnecessary complexity and potential disruptions to the user experience. There is a need for a system that enables per-tenant version management while ensuring a seamless and uninterrupted user experience.

Various embodiments described herein can address one or more of these technical problems. One or more embodiments described herein can include systems, computer-implemented methods, apparatus, or computer program products that can facilitate launching multiple versions of cloud based enterprise multi-tenant web applications within a single URL. In particular, the inventors of various embodiments described herein realized that, assuming a current version of a web application is N and a previous version is N-1, each tenant can be supported on either version N or N-1 based on their individual requirements. More particularly, the inventors realized that in a multi-tenant database architecture, each tenant’s data can be stored in a separate database, ensuring data isolation and security while maintaining operational efficiency. When a tenant is migrated from version N-1to version N, an API-driven mechanism can facilitate the upgrade process. Specifically, an API can be triggered as part of a migration workflow, initiating necessary database schema updates, data transformations, or any other modifications required to align the tenant’s database with specifications of version N. The API can interact with system version control logic to ensure that only tenants marked for migration undergo the upgrade process. Further, the inventors realized that once triggered, the API can execute predefined database scripts or migration procedures that can modify schema, update stored procedures, or ensure data integrity while transitioning to a new version. Additionally, logging and monitoring mechanisms can track migration status, allowing administrators to verify successful upgrades or address issues encountered during transition.

Accordingly, various embodiments described herein can be considered as improving management and deployment of enterprise cloud-based multi-tenant web applications by enabling seamless per-tenant version transitions while maintaining a unified user experience. By allowing tenants to individually migrate to a newer version (N) while still supporting those operating on a previous version (N-1), systems described herein can eliminate the need for bulk upgrades, thereby reducing downtime and operational risks. The ability to serve multiple application versions within a single URL can ensure consistent login experiences, preventing disruptions typically associated with version-specific URLs or redirects. Furthermore, systems described herein can accelerate deployment of new versions by removing dependencies on time-consuming Market Enablement processes, thereby allowing early adopters to transition to newer versions without needing to force all tenants to upgrade simultaneously. Furthermore, systems described herein can enhance stability by preventing modifications to N-1 versions once deployed, thereby ensuring that tenants who choose to remain on a previous version do not experience unexpected changes. Additionally, by optimizing resource utilization, systems described herein can support multiple versions efficiently without requiring redundant infrastructure. The proposed solution can therefore provide tenants with greater autonomy, allowing them to transition based on their needs or regulatory constraints. By reducing disruptions and improving overall flexibility, systems described herein can enhance efficiency, scalability, and reliability of multi-tenant cloud applications, and provide a superior user experience with more robust version management.

Various embodiments described herein can be considered as a computerized tool (e.g., any suitable combination of computer-executable hardware or computer-executable software) that can facilitate management and deployment of enterprise cloud-based multi-tenant web applications. In various aspects, such computerized tools can comprise an origin component, a token component, a compatibility component, a tenant component, or an artificial intelligence (AI) component.

In various embodiments, the origin component can retrieve application version metadata stored in a version mapping database to determine the appropriate version of an application for a given tenant. The application can be a multi-tenant enterprise cloud-based application that supports multiple versions to accommodate different tenant requirements. The origin component can determine a first origin corresponding to a first version of the application and a second origin corresponding to a second version of the application by querying a distributed configuration management system. The distributed configuration management system can store version assignments, origin mappings, and tenant-specific configuration data, such that each tenant request is routed to the correct application instance. When a request (e.g., a claim) is received, the system can evaluate the claim metadata retrieved from a version mapping database to determine whether a specific tenant version has been specified. If the claim explicitly identifies a tenant version, the compatibility component can select the corresponding origin. For example, if the claim specifies that a tenant is assigned to the second version of the application, the compatibility component can direct the request to the second origin. Alternatively, if the claim does not specify a tenant version, the compatibility component can select a default origin, such as the first origin, thereby ensuring consistent behavior for unspecified cases. The origin component can resolve a network route to either the first origin or the second origin based on computed routing decisions, ensuring that tenant requests are directed efficiently through software-defined networking (SDN) rules, API gateway configurations, or load balancer policies. The routing decisions can be based on factors such as tenant-specific versioning data, system health metrics, latency considerations, and service availability. By dynamically selecting the appropriate origin through a configuration-driven architecture, the origin component can allow for seamless multi-version support within a single application framework, ensuring that tenants are routed to the correct application version while maintaining a unified access point. Additionally, the origin component can ensure proper version control and compatibility, thereby reducing disruptions and improving the efficiency of versioned deployments in cloud-based multi-tenant environments.

In various embodiments, the token component can generate a cryptographically signed token, embed a claim within the token, and issue the token to authenticate and authorize a tenant’s access to a specific version of a multi-tenant enterprise cloud-based application. The token component can function as part of a distributed authentication system, ensuring that each tenant request is securely validated before access is granted. The token can be a cryptographically secure data structure, digitally signed using a public-private key pair stored in a secure key vault, ensuring tamper-proof integrity and verification. The token component can support industry-standard encryption methods such as RSA, ECC, or HMAC-based signing algorithms. The token component can embed a claim within the token, wherein the claim can include tenant identity, user authentication details, assigned application version (e.g., version N-1 or version N), session expiration time, and security attributes. The claim can be utilized by other system components, including the compatibility component and the origin component, to determine which application version the tenant should be routed to. If the claim explicitly specifies a tenant version, the system can select the corresponding origin for request processing. If the claim does not specify a version, the system can default to a predefined version, ensuring consistent version control and backward compatibility. The token component can issue the token through a secure authentication API, enabling seamless integration with identity management services, authorization frameworks, and security gateways. The tokens can be implemented using industry-standard authentication frameworks, such as JSON Web Tokens (JWT) or Security Assertion Markup Language (SAML), allowing for scalability, cross-platform compatibility, and secure multi-service authentication. Additionally, the token component can facilitate single sign-on (SSO) functionality, reducing the need for repeated logins while maintaining secure and efficient version-aware access control.

In various embodiments, the compatibility component can decrypt and inspect the claim within the token, extract metadata fields from the claim, evaluate the claim based on predefined routing rules, and select which origin to use. The compatibility component can function as a decision-making module that processes tenant-specific versioning information to dynamically determine the appropriate application origin for a given request. Upon receiving a tenant request, the compatibility component can decrypt the token using a cryptographic authentication service, ensuring that the claim remains tamper-proof and verifiable. The decrypted claim can include metadata fields such as a tenant identifier, assigned application version, security attributes, or contextual parameters. By leveraging predefined routing rules stored in a configuration database, the compatibility component can process the extracted metadata and dynamically select an appropriate origin, ensuring that each tenant is directed to the correct application version while maintaining compliance with system policies. When a tenant accesses the system, the compatibility component can retrieve and inspect the claim to determine whether a specific application version has been assigned. If the claim explicitly designates a version, such as version N-1 or version N, the compatibility component can select the corresponding origin and direct the request accordingly. If the claim does not specify a version, the compatibility component can apply predefined routing rules, such as defaulting to the latest stable version, to maintain system consistency. Additionally, the compatibility component can enforce version compatibility policies to ensure that tenants are only routed to versions they are authorized to access, preventing version misalignment and incompatibility issues. The compatibility component can interact with other system components, including the token component and the origin component, to ensure seamless version-aware request handling within a unified URL architecture. By automating version selection based on claim metadata, security policies, and system routing logic, the compatibility component can enable dynamic multi-version support, eliminating the need for version-specific URLs and manual version assignments. Furthermore, the compatibility component can support additional versioning strategies, such as phased rollouts, feature toggles, or controlled beta testing, allowing enterprises to implement flexible deployment models and control tenant-specific version access dynamically.

In various embodiments, when a claim is redirected to a second origin, the compatibility component can perform an evaluation to determine whether the second origin corresponds to a stable version of the application. Stability in this context can refer to the version’s reliability, performance consistency, or readiness for broader tenant adoption. The compatibility component can inspect metadata associated with the second origin, such as version release status, error rates, rollback indicators, or administrator-defined stability thresholds, to ensure that only validated and production-ready versions are assigned to tenants. If the second origin meets predefined stability criteria, the claim can be processed normally, and the tenant can be granted access to the corresponding application version. However, if the compatibility component determines that the second origin is unstable—such as when the version is in beta, undergoing phased rollout, or exhibiting performance issues—the system can apply alternative routing strategies to prevent disruptions. These strategies can include redirecting the tenant back to the first origin (previous stable version), restricting access to designated test tenants, or displaying an upgrade notification before proceeding. The compatibility component can integrate with version control and real-time monitoring systems to dynamically update stability assessments and adjust routing logic based on live system metrics. If real-time monitoring detects critical failures, increased error rates, or service degradations in the second origin, the compatibility component can automatically divert tenant traffic to a more stable origin, preventing widespread downtime and performance degradation. Conversely, when the second origin passes stability benchmarks, such as successful quality assurance checks and performance validation thresholds, the compatibility component can flag the version as stable and allow unrestricted tenant migration. By incorporating a stability verification process before assigning tenants to a new version, the compatibility component can enhance overall system reliability, ensure smooth version transitions, and minimize operational disruptions, thereby enabling enterprises to incrementally roll out new versions while maintaining high availability and optimal user experience.

In various embodiments, the tenant component can maintain and update a database of tenant version data. The tenant component can track which version of an application a tenant is currently assigned to. The tenant component can ensure accurate version control and seamless transitions during upgrades. The tenant component can interact with other system modules, such as the token component, compatibility component, or origin component, to provide a centralized mechanism for managing tenant-specific version assignments. When a tenant is initially provisioned or undergoes a version migration, the tenant component can record the assigned version in a tenant version database. The database can serve as an authoritative source for determining which application version a tenant should access. For instance, when a tenant is migrated from version N-1 to version N, the tenant component can update a corresponding entry in the database to reflect the new version. This can ensure that all subsequent authentication and routing decisions made by the compatibility component are based on up-to-date version data. Additionally, the tenant component can support automated version assignment policies (e.g., based on business rules, tenant preferences, or system stability assessments). For example, enterprise customers can opt for a controlled migration approach, where only specific tenants are upgraded to a new version initially, while others remain on a stable version until broader adoption is approved. The tenant component can maintain version flags for each tenant, thereby allowing system administrators to implement phased rollouts, beta testing, or rollback strategies. Moreover, the tenant component can facilitate auditability and compliance by logging version changes over time. This version history can allow enterprises to track tenant migrations, verify upgrade paths, or troubleshoot issues arising from version transitions. In cases where a rollback is necessary, the tenant component can restore a tenant’s version assignment to a previous stable state, ensuring minimal disruption to business operations. The tenant component can facilitate real-time updates, ensure accurate version routing, and provide enterprises with the ability to manage version transitions efficiently while maintaining a consistent and reliable user experience.

In some embodiments, the artificial intelligence component can train an AI model to analyze claims, evaluate routing rules, and determine an appropriate origin for tenant requests. The artificial intelligence component can dynamically optimize version assignments based on evolving patterns, tenant behavior, and system performance metrics. The AI model can be trained to inspect the claim metadata and extract relevant details (e.g., tenant identity, version preference, or historical version usage). By analyzing this metadata alongside routing rules, the AI component can enhance accuracy and efficiency of origin selection, ensuring that each tenant is directed to a correct version with minimal manual intervention. The AI component can be configured to train the AI model to update the database of tenant version data, allowing for intelligent version tracking and automated decision-making. By continuously learning from historical tenant migrations and version performance metrics, the AI model can predict when a tenant is likely to require an upgrade or rollback. This predictive capability can further enable proactive version management. The AI model can detect anomalies, such as inconsistent version assignments or unexpected downgrades, and trigger corrective actions to maintain data integrity and system reliability. Furthermore, the AI component can enhance system stability by training the AI model to assess whether a second origin corresponds to a stable version before routing tenants to it. Stability assessment can involve analyzing key performance indicators (KPIs), such as error rates, response times, user feedback, or system logs, to determine whether the second origin meets predefined stability thresholds. If the AI model detects performance issues or increased failure rates, it can flag the second origin as unstable and prevent tenant migrations, reducing the risk of disruptions. Conversely, if the AI model determines that the second origin meets stability criteria, it can mark it as ready for broader adoption. Upon confirming that the second origin is stable, the AI component can train the AI model to update the database of tenant version data and set the second origin as the default origin. Thus, the AI component can enable automated version promotions, where stable versions are seamlessly transitioned to the default status without requiring manual intervention. The AI model can enable predictive version routing, real-time stability assessments, and automated database updates, allowing enterprises to optimize version control while minimizing disruptions.

Various embodiments described herein can be employed to use hardware or software to solve problems that are highly technical in nature (e.g., to facilitate management and deployment of enterprise cloud-based multi-tenant web applications), that are not abstract and that cannot be performed as a set of mental acts by a human. Further, some of the processes performed can be performed by a specialized computer (e.g., graphical user interfaces, data encryption, deep learning neural networks) for carrying out defined acts related to vulnerability management. For example, such defined acts can include: issuing, by a device operatively coupled to a processor, a token containing a claim; inspecting, by the device, the claim for relevant metadata; evaluating, by the device, the claim based on routing rules; and selecting, by the device, which origin to use.

Moreover, various embodiments described herein can integrate into a practical application various teachings relating to management and deployment of enterprise cloud-based multi-tenant web applications. As described above, current deployment strategies primarily focus on infrastructure-level deployment and do not adequately address the challenge of dynamically serving different versions of a multi-tenant web application within a single URL.

Various embodiments described herein can address one or more of these technical problems. In particular, the present inventors recognized that there is a need for a system that enables per-tenant version management while ensuring a seamless and uninterrupted user experience.

Furthermore, various embodiments described herein can control real-world tangible devices based on the disclosed teachings. For example, various embodiments described herein can electronically control version transitions in multi-tenant enterprise cloud applications and can electronically train or execute real-world artificial intelligence models. Specifically, various embodiments described herein can electronically execute version-aware routing, dynamically migrate tenant databases, optimize computing resource allocation, and automate deployment decisions using microservices, container orchestration, and load balancing systems. These processes can improve efficiency, reliability, and scalability of cloud-based software applications.

Moreover, various embodiments described herein can electronically train and execute artificial intelligence models in real-world environments, enabling adaptive decision-making, predictive system optimizations, and intelligent workload distribution across enterprise cloud infrastructure. The artificial intelligence component disclosed herein can analyze live system metrics, detect performance anomalies, optimize API request routing, and manage automated database migrations. By continuously collecting and evaluating real-time data points such as API response times, database query latency, server CPU/memory utilization, and network bandwidth consumption, the AI component can identify inefficiencies, predict potential failures, and proactively optimize system behavior. Unlike conventional cloud architectures, which rely on static configurations or manually defined thresholds, the disclosed AI-driven approach can automatically adjust system parameters based on evolving conditions, leading to enhanced application stability, reduced latency, and more efficient use of computational resources. The AI component can detect performance anomalies by leveraging machine learning models, historical trend analysis, and anomaly detection algorithms to recognize deviations from expected behavior. Additionally, the AI component can optimize API request routing and manage automated database migrations by intelligently directing requests to the most optimal origin based on tenant versioning, system health, and service availability. Instead of relying on static routing rules, the AI component can analyze historical access patterns, detect version incompatibilities, and ensure that tenants are routed to the correct application version without service disruptions. In the case of database migrations, the AI component can evaluate data structure changes, schema compatibility, and migration success probabilities, ensuring that each tenant’s database is upgraded efficiently while preserving data integrity and minimizing downtime.

Embodiments described herein can directly control real-world hardware components, such as servers, load balancers, storage systems, and network gateways, to automate version assignments, manage multi-tenant data flows, and ensure stable service availability. The disclosed system does not merely recite abstract software processes but instead performs concrete computing functions that transform how multi-tenant cloud applications manage version transitions and resource provisioning at scale.

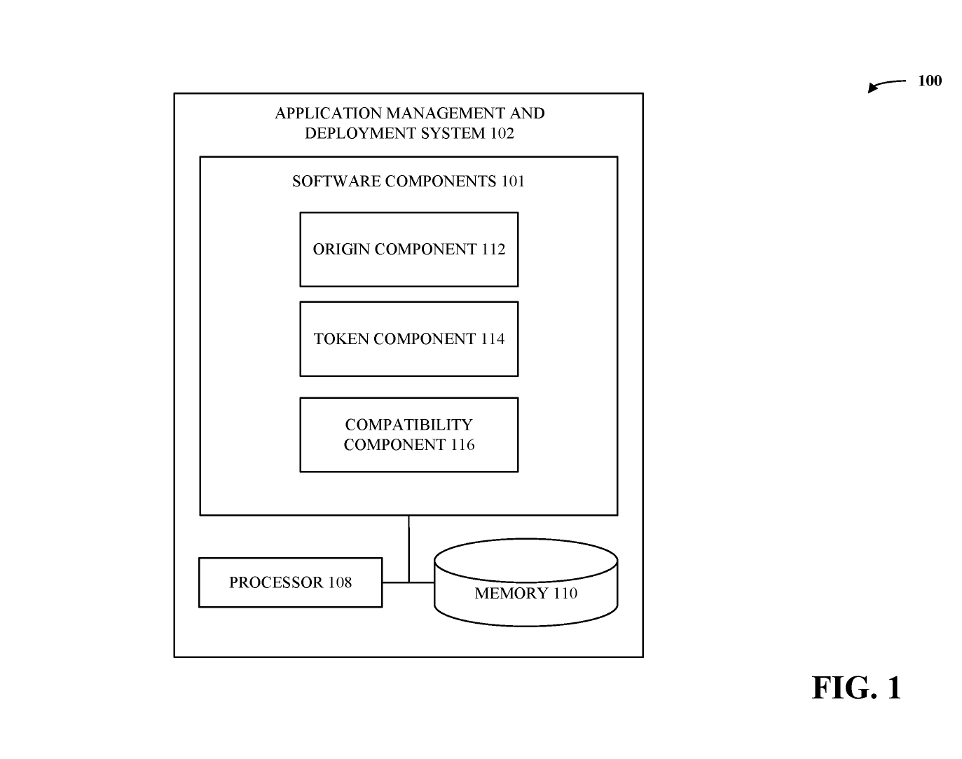

FIG. 1 illustrates a block diagram of an example, non-limiting system 100 that can facilitate management and deployment of enterprise cloud-based multi-tenant web applications. In various embodiments, the application management and deployment system 102 can comprise a processor 108 (e.g., computer processing unit, microprocessor) and a non-transitory computer-readable memory 110 that is operably or operatively or communicatively connected or coupled to the processor 108. The non-transitory computer-readable memory 110 can store computer-executable instructions which, upon execution by the processor 108, can cause the processor 108 or other components of the vulnerability management system 102 (e.g., origin component 112, token component 114, compatibility component 116) to perform one or more acts. In various embodiments, the non-transitory computer-readable memory 110 can store computer-executable components (e.g., origin component 112, token component 114, compatibility component 116), and the processor 108 can execute the computer-executable components.

In various embodiments, the application management and deployment system 102 can comprise an origin component 112. The origin component 112 can retrieve application version metadata stored in a version mapping database to determine the appropriate application version for a given tenant. The version mapping database can store tenant-specific version assignments, feature flags, and configuration settings, allowing the system to dynamically determine which application version a tenant should be routed to. The origin component 112 can further determine a first origin corresponding to a first version of an application and a second origin corresponding to a second version of the application by querying a distributed configuration management system. The distributed configuration management system can contain version deployment details, service discovery information, and routing policies, enabling real-time evaluation of available application versions and their corresponding origins. When a claim is received, the origin component 112 can process the retrieved version metadata and computed routing decisions to resolve a network route to either the first origin or the second origin. The network route resolution can involve dynamically configuring load balancers, API gateways, and software-defined networking (SDN) rules to direct the tenant request to the correct version. If the claim explicitly specifies a tenant version, the origin component 112 can ensure that the request is routed to the correct origin based on policy-driven routing logic. If the claim does not specify a version, the origin component 112 can assign a default origin, ensuring consistent routing behavior across multi-version deployments.

In various embodiments, the application management and deployment system 102 can comprise a token component 114. The token component 114 can generate a cryptographically signed token as part of the authentication and authorization process for tenant access to a multi-tenant enterprise cloud-based application. The token component 114 can utilize cryptographic algorithms, such as RSA, ECC, or HMAC, to sign the token, ensuring data integrity, security, and protection against unauthorized tampering. The private key used for signing the token can be securely stored in a key management system to prevent unauthorized access. The token component 114 can embed a claim within the token, wherein the claim can include metadata fields such as a tenant identifier, assigned application version (e.g., version N-1 or version N), authentication details, session expiration time, and security attributes. The embedded claim can be structured in industry-standard authentication frameworks, such as JSON Web Tokens (JWT) or Security Assertion Markup Language (SAML), ensuring interoperability across authentication providers. The token component 114 can then issue the token through an identity management API, enabling tenants to authenticate and securely access application services. The issued token can be used by other system components, including the origin component 112 and the compatibility component 116, to enforce version-aware request routing and access control. By dynamically encoding version-related claims within tokens, the token component 114 can prevent unauthorized access to restricted application versions, ensuring that tenants only receive access to the versions they are authorized for. Additionally, the token component 114 can facilitate single sign-on (SSO) functionality, reducing the need for repeated logins while maintaining secure session management.

In various embodiments, the application management and deployment system 102 can comprise a compatibility component 116. The compatibility component 116 can decrypt and inspect the claim within the token to extract relevant metadata fields, including tenant-specific version information, authentication credentials, and feature entitlements. The decryption process can utilize public-private key cryptography to ensure that only authorized services can access token metadata. Once the claim is decrypted, the compatibility component 116 can extract metadata fields from the claim, including tenant version assignments, security attributes, and session parameters. The compatibility component 116 can then evaluate the claim based on predefined routing rules, ensuring that tenant requests are routed to the appropriate version. These routing rules can be dynamically updated based on real-time system conditions, including application availability, load balancing constraints, and compliance policies. If the claim explicitly specifies a version, such as version N-1 or version N, the compatibility component 116 can select the corresponding origin and direct the request accordingly. If the claim does not specify a version, the compatibility component 116 can apply default routing rules, such as assigning the tenant request to the latest stable version. The compatibility component 116 can work in conjunction with the origin component 112 and token component 114 to enable seamless version-aware request handling within a single URL architecture. By automating origin selection based on claim metadata and routing logic, the compatibility component 116 can eliminate disruptions associated with version-specific URLs, enhance flexibility in version migration, and ensure a smooth transition for tenants upgrading to a newer version. Additionally, the compatibility component 116 can support advanced versioning strategies, such as phased rollouts, feature toggles, and controlled beta testing, enabling enterprises to exercise fine-grained control over version deployments and tenant-specific version access.

In various embodiments, when a claim is redirected to a second origin, the compatibility component 116 can evaluate whether the second origin corresponds to a stable version of the application. The stability evaluation can consider performance reliability, error rates, rollback indicators, and administrator-defined stability thresholds. If the second origin meets predefined stability criteria, the compatibility component 116 can allow the claim to be processed normally, granting the tenant access to the requested version. If the second origin is unstable—for instance, if it is in beta testing, undergoing phased rollout, or experiencing service degradations—the compatibility component 116 can apply alternative routing strategies, such as redirecting the tenant back to the first origin (previous stable version), restricting access to designated test tenants, or displaying an upgrade notification before proceeding. The compatibility component 116 can integrate with version control systems, monitoring services, and health-check APIs to dynamically update stability assessments. If real-time monitoring detects critical failures, increased error rates, or degraded performance in the second origin, the compatibility component 116 can automatically divert tenant traffic to a more stable origin, preventing widespread service disruptions. Conversely, when the second origin passes quality assurance benchmarks and reaches a predefined stability threshold, the compatibility component 116 can flag the version as stable, allowing unrestricted tenant migration.

In various embodiments, when the origin corresponding to the tenant version is unavailable, the compatibility component 116 can dynamically select a new origin corresponding to a previous version of the application to ensure continued system availability and uninterrupted access. The compatibility component 116 can monitor real-time availability metrics, system health checks, and failure indicators to detect when an assigned origin experiences downtime, performance degradation, or fails to meet stability thresholds. If the selected origin is unavailable due to server failure, maintenance, or high traffic loads, the compatibility component 116 can retrieve historical versioning data, deployment records, and system failover policies from the distributed configuration management system to identify a fallback origin corresponding to a previous stable version of the application.

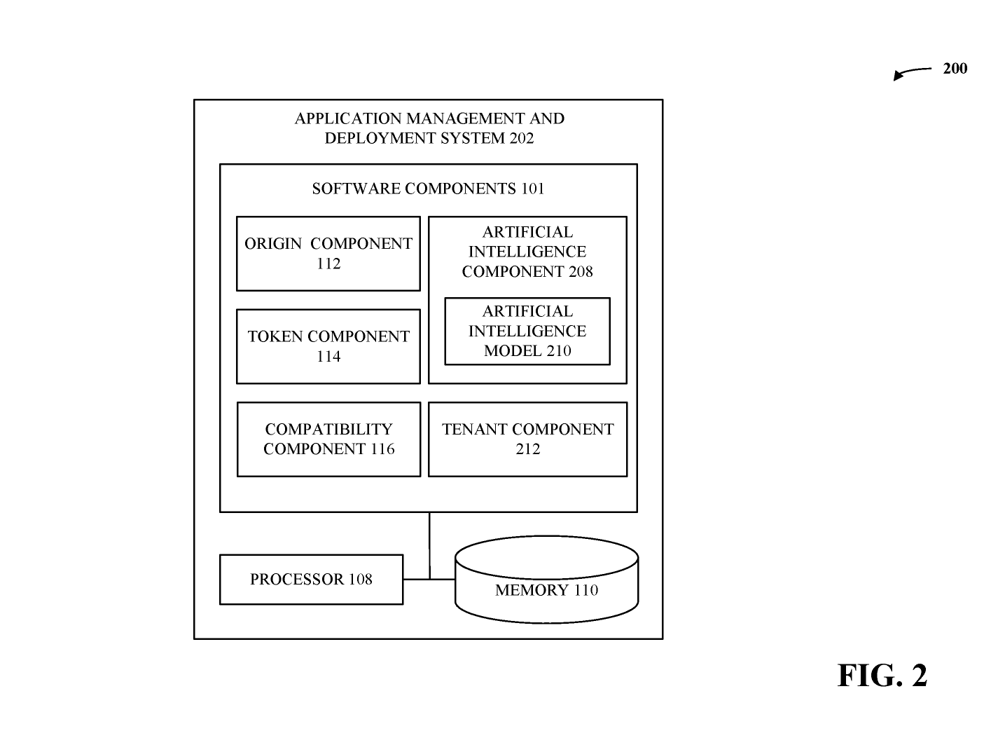

FIG. 2 illustrates a block diagram of an example, non-limiting system 200 that facilitates management and deployment of enterprise cloud-based multi-tenant web applications. As shown, the system 200 can, in some cases, comprise the same components as the system 100, and can further comprise an artificial intelligence component 208 and a tenant component 212.

In various embodiments, the artificial intelligence component 208 can train an AI model 210 to analyze claims, evaluate routing rules, and determine an appropriate origin for tenant requests. The artificial intelligence component 208 can dynamically optimize version assignments based on evolving patterns, tenant behavior, and system performance metrics. The AI model 210 can be trained to inspect the claim metadata and extract relevant details (e.g., tenant identity, version preference, or historical version usage). By analyzing this metadata alongside routing rules, the AI component 208 can enhance accuracy and efficiency of origin selection, ensuring that each tenant is directed to a correct version with minimal manual intervention. The AI component 208 can be configured to train the AI model 210 to update the database of tenant version data, allowing for intelligent version tracking and automated decision-making. By continuously learning from historical tenant migrations and version performance metrics, the AI model 210 can predict when a tenant is likely to require an upgrade or rollback. This predictive capability can further enable proactive version management. The AI model 210 can detect anomalies, such as inconsistent version assignments or unexpected downgrades, and trigger corrective actions to maintain data integrity and system reliability. Furthermore, the AI component 208 can enhance system stability by training the AI model 210 to assess whether a second origin corresponds to a stable version before routing tenants to it. Stability assessment can involve analyzing key performance indicators (KPIs), such as error rates, response times, user feedback, or system logs, to determine whether the second origin meets predefined stability thresholds. If the AI model 210 detects performance issues or increased failure rates, it can flag the second origin as unstable and prevent tenant migrations, reducing the risk of disruptions. Conversely, if the AI model 210 determines that the second origin meets stability criteria, it can mark it as ready for broader adoption. Upon confirming that the second origin is stable, the AI component 208 can train the AI model to update the database of tenant version data and set the second origin as the default origin. Thus, the AI component 208 can enable automated version promotions, where stable versions are seamlessly transitioned to the default status without requiring manual intervention. The AI model 210 can enable predictive version routing, real-time stability assessments, and automated database updates, allowing enterprises to optimize version control while minimizing disruptions.

In various aspects, the tenant component 212 can maintain and update a database of tenant version data. The tenant component 212 can track which version of an application a tenant is currently assigned to. The tenant component 212 can ensure accurate version control and seamless transitions during upgrades. The tenant component 212 can interact with other system modules, such as the token component 114, compatibility component 116, or origin component 112, to provide a centralized mechanism for managing tenant-specific version assignments. When a tenant is initially provisioned or undergoes a version migration, the tenant component 212 can record the assigned version in a tenant version database. The database can serve as an authoritative source for determining which application version a tenant should access. For instance, when a tenant is migrated from version N-1 to version N, the tenant component 212 can update a corresponding entry in the database to reflect the new version. This can ensure that all subsequent authentication and routing decisions made by the compatibility component 116 are based on up-to-date version data. Additionally, the tenant component 212 can support automated version assignment policies (e.g., based on business rules, tenant preferences, or system stability assessments). For example, enterprise customers can opt for a controlled migration approach, where only specific tenants are upgraded to a new version initially, while others remain on a stable version until broader adoption is approved. The tenant component 212 can maintain version flags for each tenant, thereby allowing administrators to implement phased rollouts, beta testing, or rollback strategies. Moreover, the tenant component 212 can facilitate auditability and compliance by logging version changes over time. This version history can allow enterprises to track tenant migrations, verify upgrade paths, or troubleshoot issues arising from version transitions. In cases where a rollback is necessary, the tenant component 212 can restore a tenant’s version assignment to a previous stable state, ensuring minimal disruption to business operations. The tenant component 212 can facilitate real-time updates, ensure accurate version routing, and provide enterprises with the ability to manage version transitions efficiently while maintaining a consistent and reliable user experience.

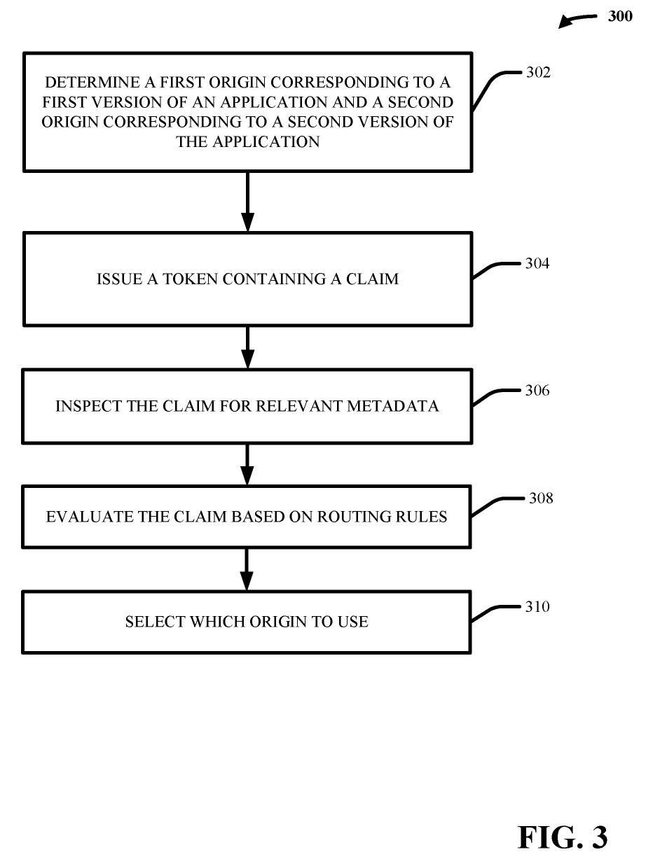

FIG. 3 illustrates a flow diagram of an example, non-limiting computer-implemented method 300 that can facilitate management and deployment of enterprise cloud-based multi-tenant web applications in accordance with one or more embodiments described herein.

In various embodiments, act 302 can include determining, by a device (e.g., via 112) operatively coupled to a processor (e.g., 108), a first origin corresponding to a first version of an application and a second origin corresponding to a second version of the application. The first origin and the second origin can represent different deployment environments, service endpoints, or application instances that are maintained simultaneously within a multi-tenant cloud-based system. The determination of the first origin and the second origin can allow a system (e.g., 202) to route users to an appropriate version of the application while maintaining a unified access experience. To facilitate this determination, act 302 can include retrieving application version metadata stored in a version mapping database. The version mapping database can store tenant-specific version assignments, feature compatibility settings, update history, and rollback conditions. The retrieved metadata can allow the system to analyze which version of the application a tenant should be directed to, based on predefined policies, stability assessments, and system health metrics. Additionally, the determination of the first origin and the second origin can involve querying a distributed configuration management system to obtain real-time deployment status, origin availability, and version-specific service configurations. The distributed configuration management system can contain data related to live deployments, microservice dependencies, containerized environments, and load-balancing strategies, ensuring that version assignments are dynamically updated based on system conditions. The system can use this queried data to assess which origin is optimal for a given request based on factors such as tenant preferences, system constraints, and administrator-defined rollout schedules. Once the first origin and second origin are determined, act 302 can further include resolving a network route to either the first origin or the second origin based on computed routing decisions. The network route resolution can involve dynamically configuring load balancers, API gateways, and software-defined networking (SDN) rules to direct the tenant request to the correct version. The routing decisions can be computed based on real-time traffic analysis, tenant-specific versioning data, and pre-configured system policies, ensuring an optimized and stable request-handling mechanism..

Additionally, the determination of the first origin and the second origin can be dynamic and adaptive to system conditions, tenant preferences, or administrative policies. For example, an artificial intelligence component (e.g., 208) can train a model (e.g., 210) to analyze historical routing data, monitor application performance, and evaluate stability metrics to optimize the assignment of tenants to the first origin or the second origin. If the second version of the application is still undergoing phased deployment or beta testing, the system (e.g., 202) can restrict access to the second origin for only a subset of tenants until stability thresholds are met. Conversely, if the second origin is confirmed as stable, the system can update tenant version assignments and begin routing additional tenants to the second version of the application..

In various embodiments, act 304 can include issuing, by a device (e.g., via 114) operatively coupled to a processor (e.g., 108), a token containing a claim. Before issuing the token, act 304 can include generating a cryptographically signed token to ensure secure authentication and verification. The token can be digitally signed using cryptographic algorithms such as RSA, ECC, or HMAC, with the private key stored in a secure key vault to prevent unauthorized access. The cryptographic signature can be used to validate the token’s authenticity and integrity upon future verification requests. Once generated, act 304 can include embedding a claim within the token, wherein the claim can include tenant-specific metadata, authentication details, assigned application version (e.g., version N-1 or version N), session expiration time, and access control attributes. Embedding this structured data within the token allows the system to ensure version-aware authentication and enforce role-based access control policies. The claim can be encoded using standard authentication frameworks such as JSON Web Tokens (JWT) or Security Assertion Markup Language (SAML), ensuring interoperability across cloud-based identity providers. After embedding the claim, act 304 can further include issuing the token, allowing the tenant to access the system with a secure, verifiable authentication credential. The issued token can be used by other system components, including the origin component (112) and the compatibility component (116), to determine appropriate version routing and access control settings..

The authentication details embedded in the token can include user identity, login status, session duration, and access privileges, which can ensure that only authenticated users gain entry to a multi-tenant cloud-based system. The authentication parameters within the token can help enforce session management policies, including token expiration, renewal mechanisms, and multi-factor authentication requirements. The tenant identity encoded in the token can ensure that a multi-tenant cloud-based system (e.g., 202) differentiates users across multiple tenants, which can prevent unauthorized data access between different organizations. The tenant identity within the token can allow a multi-tenant cloud-based system to dynamically apply tenant-specific configurations, permissions, and data segmentation policies without requiring separate authentication processes for each tenant.

Additionally, the token can contain versioning information, which can be crucial for routing users to the appropriate application version within a multi-tenant cloud-based system (e.g., 202). The claim within the token can specify whether the tenant is assigned to version N-1 (previous version) or version N (current version), which can enable the compatibility component 116 to make an informed decision about which origin to direct the user to. If the claim within the token lacks explicit version information, the compatibility component 116 can enforce default routing rules, which can ensure a seamless and predictable user experience. The versioning data within the token can also help enforce feature availability policies, where different tenants can have access to specific features or UI components based on their assigned version.

In various embodiments, act 306 can include inspecting, by a device (e.g., via 116) operatively coupled to a processor (e.g., 108), the claim for relevant metadata. The inspecting 306 can allow a multi-tenant cloud-based system (e.g., 202) to extract critical information from the claim to facilitate authentication, authorization, and version-specific routing. Before the claim can be processed, act 306 can include decrypting and inspecting the claim within the token to extract critical metadata used for authentication, authorization, and version-aware routing. The decryption process can be performed using public-private key cryptography or symmetric encryption mechanisms, ensuring that only authorized services can read token metadata. Once decrypted, act 306 can include extracting metadata fields from the claim, such as tenant identity, version assignment, security attributes, and access permissions. Claim inspection 306 can be an essential step in ensuring that tenant requests are processed accurately and that users are directed to an appropriate version of an application. The inspection 306 of the claim for relevant metadata can involve analyzing various attributes encoded within the claim, such as tenant identity, user role, access privileges, assigned application version, session expiration time, and security policies. For example, the compatibility component 116 can retrieve metadata and use it to determine whether a tenant should be directed to a first origin corresponding to a first version of an application or a second origin corresponding to a second version of an application. Additionally, the inspection process 306 can allow a system (e.g., 202) to verify the integrity, validity, and authenticity of the claim, ensuring that the metadata has not been tampered with or altered. In an example use case, the artificial intelligence component 208 can further enhance the claim inspection process by training a model (e.g., 210) to analyze claim metadata, detect inconsistencies, and predict optimal routing decisions. The AI model (e.g., 210) can evaluate historical claim data, system performance trends, and tenant-specific behavior to refine metadata analysis and improve routing accuracy. Additionally, the inspection process 306 can support dynamic access control policies, allowing the system (e.g., 202) to determine whether a tenant is authorized to access specific features, UI elements, or API endpoints based on the metadata extracted from the claim.

In various embodiments, act 308 can include evaluating, by a device (e.g., via 116) operatively coupled to a processor (e.g., 108), the claim based on predefined routing rules. The evaluation process can analyze tenant-specific versioning data, system constraints, and routing policies to determine whether the tenant should be assigned to a specific origin. In an example, compatibility component 116 can retrieve claim metadata and apply routing logic to determine whether a tenant request should be directed to a first origin corresponding to a first version of an application or a second origin corresponding to a second version of an application. If the claim specifies a tenant version, the system can verify compatibility and enforce version-specific policies. If the claim does not specify a version, default routing rules can be applied, ensuring that the tenant request is processed consistently and directed to an appropriate application version. To optimize evaluation, the AI model (e.g., 210 via 208) can be trained to analyze historical routing patterns, detect anomalies, and refine decision-making based on real-time system metrics. The AI-driven evaluation process can also support adaptive load balancing, allowing the system to distribute tenant requests based on server performance metrics, error rates, and stability indicators.

In various embodiments, act 310 can include selecting, by a device (e.g., via 116) operatively coupled to a processor (e.g., 108), which origin to use. The selection process can be based on analyzing claim metadata, routing rules, and system conditions to determine whether to direct a request to a first origin corresponding to a first version of an application or a second origin corresponding to a second version of an application. Analyzing claim metadata, routing rules, and system conditions, can improve a decision on whether to direct a request to a first origin corresponding to a first version of an application or a second origin corresponding to a second version of an application. The selection 310 of which origin to use can be based on multiple factors, including the version specified in the claim, tenant-specific version assignments, feature availability policies, stability metrics, and system load balancing constraints. Claim metadata can be retrieved and routing logic applied to determine a most appropriate origin based on predefined rules or real-time system conditions. If the claim explicitly specifies a tenant version, the corresponding origin can be selected. If the claim does not contain a version designation, a predefined origin can be defaulted to, ensuring that users are routed correctly even in the absence of explicit version data. The selection process can be enhanced through AI-driven optimization, where the AI model (e.g., 210 via 208) analyzes historical tenant routing behavior, application performance trends, and system resource utilization to predict which origin will provide the best performance and stability for a given tenant. If the claim explicitly specifies a tenant version, the corresponding origin can be selected. If the claim does not contain a version designation, the system can default to a predefined origin, ensuring consistent version control and seamless tenant experience.

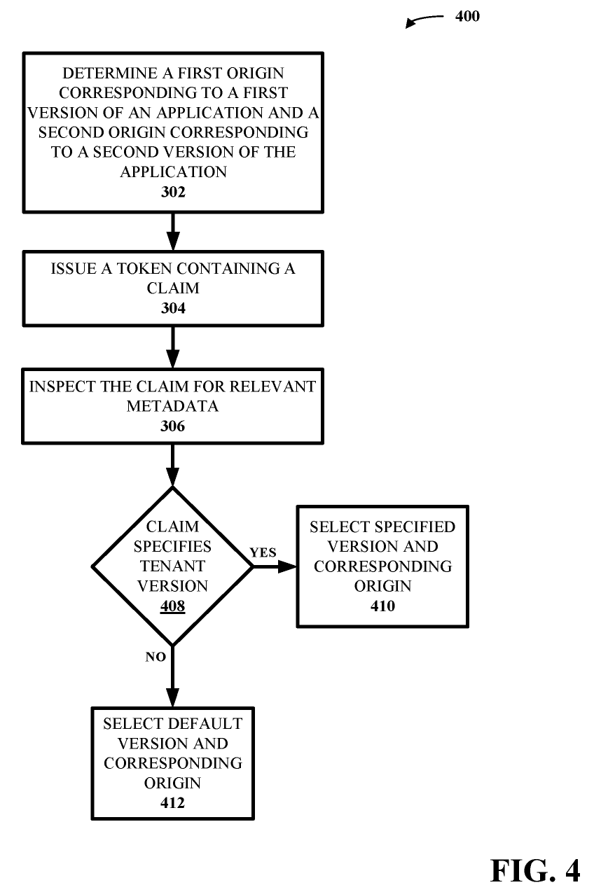

FIG. 4 illustrates a flow diagram of an example, non-limiting computer-implemented method 400 that can facilitate management and deployment of enterprise cloud-based multi-tenant web applications in accordance with one or more embodiments described herein. Repeated descriptions of like elements have been omitted for brevity.

In various embodiments, act 408 can include determining, by a device (e.g., via 116) operatively coupled to a processor (e.g., 108), whether a claim specifies a tenant version. If the claim specifies a tenant version, the method 400 can proceed to 410. If the claim does not specify a tenant version, the method 400 can proceed to 412.

In some embodiments, act 410 can include selecting, by a device (e.g., via 116) operatively coupled to a processor (e.g., 108), the specified version and corresponding origin.

In various embodiments, act 412 can include selecting, by a device (e.g., via 116) operatively coupled to a processor (e.g., 108), a default version and corresponding origin.

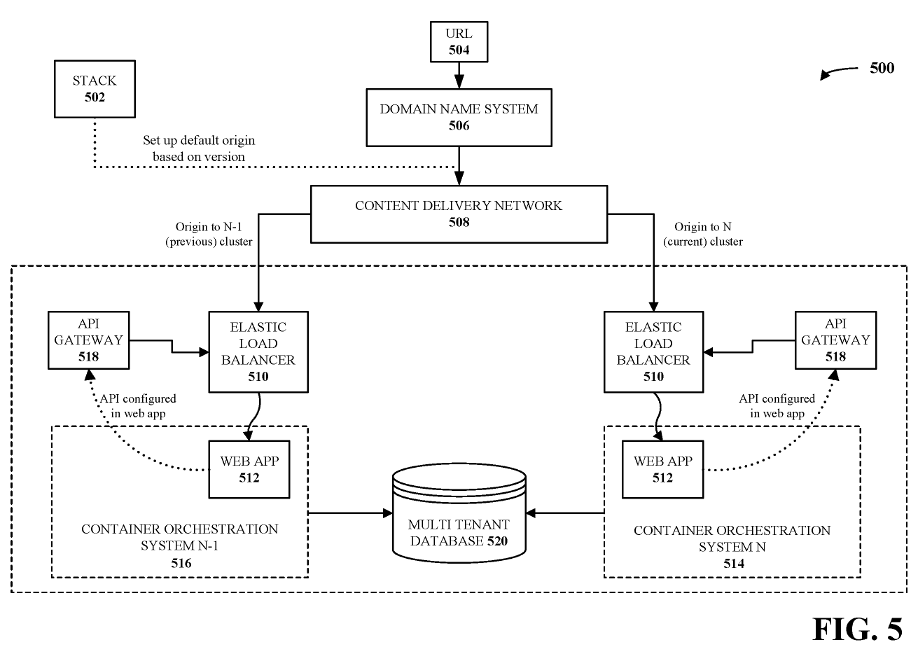

Next, FIG. 5 illustrates an example, non-limiting system architecture 500 that can facilitate management and deployment of enterprise cloud-based multi-tenant web applications in accordance with one or more embodiments described herein.

System architecture 500 can include stack 502. Stack 502 can serve as a structured framework for managing multi-tenant application deployment, version control, and request routing. Stack 502 can be a collection of software components, services, and processing layers that work together to execute key functionalities within a system. Stack 502 can comprise multiple layers, including networking, application logic, database management, authentication services, and version control mechanisms, enabling efficient and scalable operations in a cloud-based environment. Stack 502 can facilitate request processing and version-aware routing by ensuring that each incoming request is properly authenticated, analyzed, and directed to the correct application version origin. The compatibility component 116, origin component 112, and token component 114 can be integrated within stack 502 to support dynamic version selection, security enforcement, and feature availability management. When a user logs in or accesses a service, stack 502 can process claim metadata contained in a token to determine a tenant’s assigned version and ensure proper request handling. Additionally, stack 502 can set up a default origin based on version to maintain consistency in routing logic when no explicit version is specified. If a tenant request lacks a version designation, stack 502 can apply predefined routing policies to assign the request to a default origin, ensuring that users are directed to a stable and approved application version.

System architecture 500 can include URL (Uniform Resource Locator) 504. URL 504 can serve as a unified access point for multi-tenant application deployment, authentication, and version-aware request routing. URL 504 can function as a standardized web address that tenants can use to access a multi-tenant cloud-based application. When a user accesses URL 504, the system can inspect claim metadata, determine a correct version, and route a request accordingly. Tenants assigned to version N-1 (previous version) can thus continue to receive a stable experience, while tenants authorized for version N (current version) can be seamlessly directed to an updated environment.

System architecture 500 can include domain name system (DNS) 506. Domain name system 506 can serve as a foundational component for resolving domain names, managing traffic distribution, and directing tenant requests to the appropriate application version. The DNS 506 can function as a hierarchical and decentralized naming system that translates human-readable domain names into IP addresses, enabling seamless access to cloud-based multi-tenant applications. DNS 506 can play a critical role in ensuring that tenant requests are properly routed to the correct origin based on version control, system load balancing, and tenant-specific configurations. DNS 506 can facilitate version-aware request routing by dynamically resolving domain names to different application instances or service endpoints. When a tenant accesses URL 504, DNS 506 can determine whether the request should be directed to a first origin corresponding to a first version of the application or a second origin corresponding to a second version of the application. Additionally, DNS 506 can set up a default origin based on version to handle cases where a request does not explicitly specify which application version should be used. If a tenant has not been assigned to a specific version, DNS 506 can resolve the request to a default origin, ensuring that the user is directed to a stable and authorized version of the application. The default origin selection process can be influenced by administrative policies, AI-driven performance analysis, and real-time system stability assessments, allowing for automated and intelligent version control. DNS 506 can also support global traffic management, latency-based routing, and failover mechanisms to enhance system resilience and availability. If an unstable origin is detected, DNS 506 can automatically redirect requests to an alternate version or backup instance, ensuring minimal service disruptions and maximum system reliability.

System architecture 500 can include content delivery network (CDN) 508. Content delivery network 508 can serve as a distributed network of edge servers designed to optimize content delivery, enhance application performance, and improve scalability for multi-tenant cloud-based applications. CDN 508 can function by caching and distributing static and dynamic content across multiple geographically distributed servers, reducing latency and minimizing the load on origin servers. CDN 508 can play a critical role in accelerating page load times, optimizing bandwidth usage, and providing a seamless user experience regardless of a tenant’s physical location. CDN 508 can facilitate version-aware content distribution by ensuring that tenants accessing different application versions receive the correct static and dynamic assets associated with their assigned version. When a tenant request is processed through URL 504 and resolved via domain name system (DNS) 506, CDN 508 can retrieve and deliver cached resources from edge servers, reducing the dependency on the primary origin servers. Additionally, CDN 508 can set up a default origin based on version to manage content caching and distribution more efficiently. If a tenant request does not explicitly specify a version, CDN 508 can apply predefined caching rules to serve content from a default origin, ensuring that users receive a stable and authorized version of application resources. The default origin selection process can be dynamically influenced by routing policies, AI-driven performance optimizations, and real-time monitoring of resource demand, allowing for automated and intelligent content management. CDN 508 can also support load balancing, failover mechanisms, and security protections to enhance system reliability and resilience. If an unstable application version is detected, CDN 508 can intelligently adjust caching policies or reroute traffic to an alternate version, ensuring that tenants experience minimal service disruptions and high availability.

System architecture 500 can include elastic load balancer (ELB) 510. Elastic load balancer 510 can serve as a scalable traffic distribution mechanism designed to optimize request handling, balance workloads across multiple instances, and enhance application availability in a multi-tenant cloud-based system. ELB 510 can function by dynamically distributing incoming network traffic across multiple application servers or origins, ensuring optimal resource utilization, reduced latency, and improved fault tolerance. ELB 510 can play a critical role in scaling application performance, mitigating service disruptions, and maintaining a seamless user experience for tenants operating on different application versions. ELB 510 can facilitate version-aware request balancing by intelligently directing tenant requests to the correct application version origin based on tenant assignments, claim metadata, and system conditions. When a tenant accesses URL 504, and the request is resolved through domain name system (DNS) 506, ELB 510 can analyze claim metadata, system health status, and load balancing policies to determine whether the request should be routed to a first origin corresponding to a first version of the application or a second origin corresponding to a second version of the application. ELB 510 can set up a default origin based on version to maintain consistent routing behavior and prevent misdirected traffic. If a tenant request does not explicitly specify an application version, ELB 510 can apply predefined load balancing rules to direct the request to a default origin. ELB 510 can also support high availability, auto-scaling, and failover mechanisms to enhance system resilience and operational efficiency. If an unstable application version is detected, ELB 510 can automatically reroute traffic to a stable backup origin or distribute the load across healthier instances.

System architecture 500 can include web application 512. Web application 512 can serve as a primary interface and functional layer for tenants interacting with a multi-tenant cloud-based system. Web application 512 can function as a browser-based software platform that provides business logic, user interface elements and application services to users across different tenants. Web application 512 can facilitate version-aware user interactions.

System architecture 500 can include container orchestration systems 514 and 516, which can serve as the management layer for deploying, scaling, and maintaining containerized application instances in a multi-tenant cloud-based system. As used herein, the term “container orchestration system” can refer to a platform that automates the deployment, networking, scaling, and lifecycle management of application containers. Container orchestration system 514 can correspond to a version N (e.g., a current version) and can manage all containerized workloads and services that belong to tenants operating on the latest version of the application. Conversely, container orchestration system 516 can correspond to version N-1 (e.g., a previous version) and can maintain workloads and application instances for tenants who have not yet transitioned to the latest version N.

System architecture 500 can include API gateway 518. API gateway 518 can serve as a centralized entry point for managing, routing, and securing API requests within a multi-tenant cloud-based system. API gateway 518 can function as an intermediary layer between clients and backend services.

System architecture 500 can include multi-tenant database 520. Database 520 can serve as the centralized data storage and management system for handling tenant-specific data in a multi-tenant cloud-based environment. Multi-tenant database 520 can function as a shared or isolated data storage architecture that allows multiple tenants to access application data. Multi-tenant database 520 can store various types of data essential for the operation of a multi-tenant cloud-based application, including user authentication data, tenant-specific configurations, transactional records, application logs, and metadata related to versioning and feature access. Tenant data can be structured to ensure logical separation while maintaining efficient query performance, and updates to stored data can occur through automated migration scripts, API-driven updates, scheduled batch processes, or real-time transactional operations. When a new application version is introduced, database schemas can be updated through controlled migrations, ensuring backward compatibility while incorporating necessary modifications. Data integrity can be maintained by enforcing constraints, validation mechanisms, and rollback procedures. Additionally, tenant-specific settings and feature flags can be dynamically adjusted to reflect version transitions.

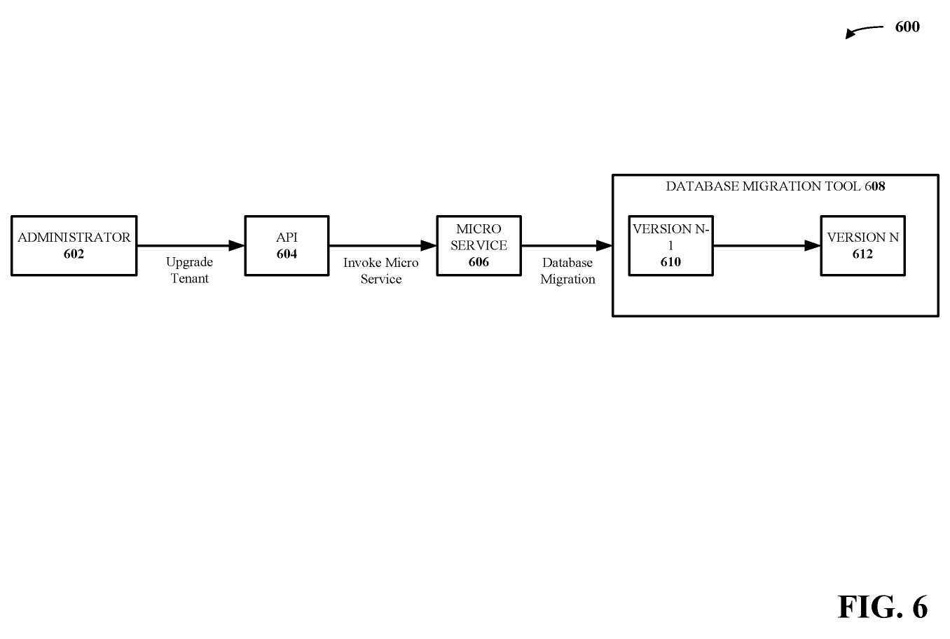

FIG. 6 illustrates an example, non-limiting system architecture 600 that can facilitate management and deployment of enterprise cloud-based multi-tenant web applications in accordance with one or more embodiments described herein.

602 can comprise an administrator that can oversee the management, configuration, and monitoring of a multi-tenant cloud-based system. The administrator 602 can be responsible for controlling version assignments, configuring tenant-specific settings, managing system policies, and overseeing deployment processes. Administrator 602 can provide new tenants, enforce access control policies, monitor application performance, and initiate version migrations. In various embodiments, the system administrator 602 can initiate and oversee the upgrade process for a tenant. After the upgrade is executed, the system administrator 602 can monitor real-time logs, performance metrics, and tenant feedback to confirm a successful migration. If issues are detected, the administrator 602 can roll back the tenant to a previous stable version or apply corrective measures to resolve compatibility concerns.

604 can comprise an API that can be used to invoke a microservice 606. The microservices 606 can be responsible for a distinct application function, such as tenant management or database migration. Microservices 606 can ensure that tenant databases are properly upgraded when transitioning from a previous application version 610 (N-1) to a current version 612 (N) using database migration tool 608. Database migration tool 608 can be a specialized software utility designed to facilitate the automated migration of tenant databases. Database migration tool 608 can be responsible for executing schema modifications, data transformations, index optimizations, and compatibility updates and can ensure that tenant databases are properly aligned with requirements of a newer application version.

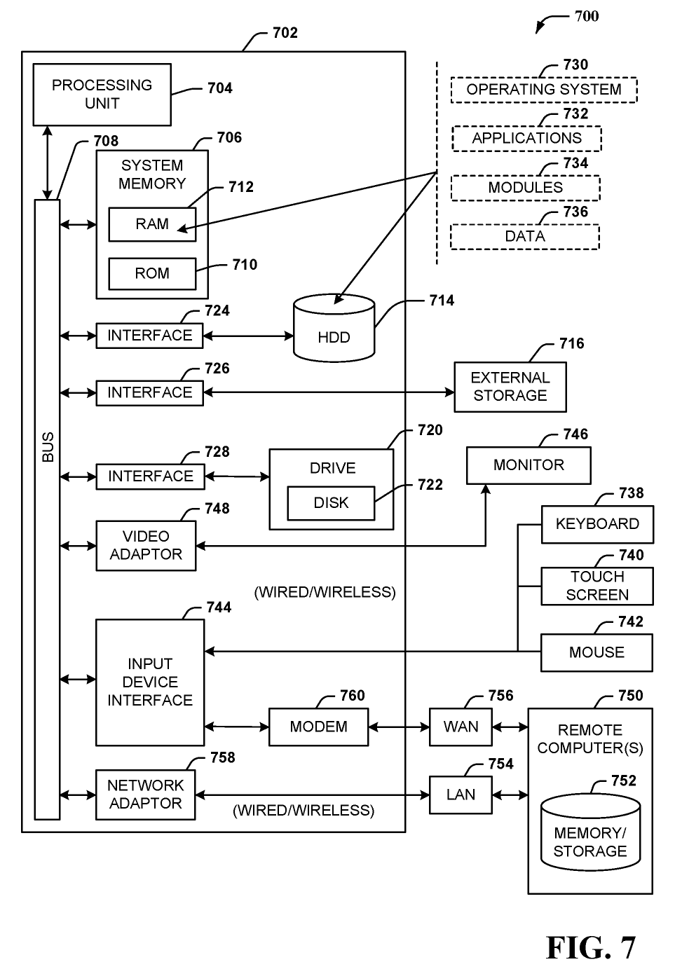

In order to provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and a drive 720, e.g., such as a solid state drive, an optical disk drive, which can read or write from a disk 722, such as a CD-ROM disc, a DVD, a BD, etc. Alternatively, where a solid state drive is involved, disk 722 would not be included, unless separate. While the internal HDD 714 is illustrated as located within the computer 702, the internal HDD 714 can also be configured for external use in a suitable chassis (not shown). Additionally, while not shown in environment 700, a solid state drive (SSD) could be used in addition to, or in place of, an HDD 714. The HDD 714, external storage device(s) 716 and drive 720 can be connected to the system bus 708 by an HDD interface 724, an external storage interface 726 and a drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can also be connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above, such as but not limited to a network virtual machine providing one or more aspects of storage or processing of information. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Various embodiments can be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The disclosure herein describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in memory, wherein the computer executable components comprise:
an origin component that retrieves application version metadata stored in a version mapping database, determines a first origin corresponding to a first version of an application and a second origin corresponding to a second version of the application by querying a distributed configuration management system, and resolves a network route to either the first origin or the second origin based on computed routing decisions;
a token component that generates a cryptographically signed token, embeds a claim within the token, and issues the token;
a compatibility component that decrypts and inspects the claim within the token, extracts metadata fields from the claim, evaluates the claim based on predefined routing rules, and selects which origin to use.

2. The system of claim 1, wherein the claim specifies a tenant version and the compatibility component selects the first origin if the tenant version of the claim specifies the first version of the application and the compatibility component selects the second origin if the tenant version of the claim specifies the second version of the application.

3. The system of claim 2, wherein the compatibility component launches tenants on different versions of the application in response to a selection of a single URL.

4. The system of claim 1, wherein the claim does not specify a tenant version and the compatibility component selects a default origin.

5. The system of claim 4, wherein the default origin is the first origin.

6. The system of claim 5, wherein the claim is redirected to the second origin and the compatibility component determines whether the second origin is a stable version.

7. The system of claim 6, wherein the compatibility component determines the second origin is a stable version and updates the default origin to be the second origin.

8. The system of claim 2, wherein the origin corresponding to the tenant version is unavailable, and the compatibility component selects a new origin corresponding to a previous version of the application.

9. The system of claim 1, further comprising a tenant component that updates a database of tenant version data.

10. The system of claim 9, wherein the compatibility component determines the second origin is a stable version, and the tenant component upgrades the tenant database.

11. The system of claim 1, further comprising an artificial intelligence component that trains an artificial intelligence model to inspect the claim for relevant metadata, evaluate the claim based on routing rules, and select which origin to use.

12. The system of claim 11, wherein the artificial intelligence component further trains the artificial intelligence model to update a database of tenant version data.

13. The system of claim 12, wherein the artificial intelligence component further trains the artificial intelligence model to determine if the second origin is a stable version.

14. The system of claim 13, wherein the artificial intelligence component further trains the artificial intelligence model to, upon determining that the second origin is a stable version, update the database of tenant version data to select the second origin as a default origin.

15. The system of claim 1, wherein the application is a multi-tenant enterprise cloud based application.

16. A computer-implemented method, comprising:
retrieving application version metadata stored in a version mapping database;
determining a first origin corresponding to a first version of an application and a second origin corresponding to a second version of the application by querying a distributed configuration management system;
resolving a network route to either the first origin or the second origin based on computed routing decisions;
generating a cryptographically signed token;
embedding a claim within the token;
issuing the token;
decrypting and inspecting the claim within the token;
extracting metadata fields from the claim;
evaluating the claim based on predefined routing rules; and
selecting which origin to use.

17. The method of claim 16, wherein the claim specifies a tenant version.

18. The method of claim 17, further comprising selecting an origin corresponding to the specified tenant version.

19. The method of claim 16, further comprising selecting a first origin if the tenant version of the claim specifies a first version of the application and selecting a second origin if the tenant version of the claim specifies a second version of the application.

20. A non-transitory machine-readable storage medium, comprising executable instructions that, when executed by a processor, facilitate performance of operations, comprising:
retrieving application version metadata stored in a version mapping database;
determining a first origin corresponding to a first version of an application and a second origin corresponding to a second version of the application by querying a distributed configuration management system;
resolving a network route to either the first origin or the second origin based on computed routing decisions;
generating a cryptographically signed token;
embedding a claim within the token;
issuing the token;
decrypting and inspecting the claim within the token;
extracting metadata fields from the claim;
evaluating the claim based on predefined routing rules; and
selecting which origin to use.
